(19) United States
(12) Patent Application Publication
(10) Pub. No.: US 2026/0310396 A1
(43) Pub. Date: Oct. 8, 2026

(54) SYSTEM, AND INFORMATION PROCESSING DEVICE

(71) Applicant: TOYOTA JIDOSHA KABUSHIKI KAISHA, Toyota-shi (JP)

(72) Inventors: Hirotake SANO, Nagakute-shi (JP); Takashi OSAWA, Toyota-shi (JP); Ryota HAMABE, Nisshin-shi (JP); Miki TSUJINO, Ichinomiya-shi (JP); Shintaro MATSUTANI, Kariya-shi (JP); Hisashi FUJIWARA, Nisshin-shi (JP)

(73) Assignee: TOYOTA JIDOSHA KABUSHIKI KAISHA, Toyota-shi (JP)

(21) Appl. No.: 19/462,092

(22) Filed: Jan. 28, 2026

(30) Foreign Application Priority Data
Feb. 7, 2025 (JP) 2025-018990

(51) Int. Cl. G06F 3/14

(52) U.S. Cl. CPC G06F 3/1423

(57) ABSTRACT

A system includes a display device, an in-vehicle device that includes an information processing device including a processor, a server, and a user terminal. The display device includes a pair of displays arranged on a left side and a right side of a steering wheel and including a touch panel. The processor stores information regarding an indicator displayed on a meter portion in a storage device, output to the display device, a command to display a screen in accordance with the information regarding the indicator on the pair of displays, and transmit information for displaying a first screen on the user terminal to the user terminal or the server. The first screen is the screen in accordance with the information regarding the indicator displayed on the meter portion.

### CROSS-REFERENCE TO RELATED APPLICATION

This application claims priority to Japanese Patent Application No. 2025-018990 filed on Feb.7, 2025. The disclosure of the above-identified application, including the specification, drawings, and claims, is incorporated by reference herein in its entirety.

### BACKGROUND

### 1. Technical Field

The present disclosure relates to a system, and an information processing device.

### 2. Description of Related Art

A system including a center display and a meter display that display information and switching display of the information between the center display and the meter display in accordance with confidentiality of the information is known (see, for example, Japanese Unexamined Patent Application Publication No. 2005-022590 (JP 2005-022590 A)).

### SUMMARY

An object of the present disclosure is to make it easier for a user to confirm an indicator displayed in a vehicle.

A system according to one aspect of the present disclosure includes an in-vehicle device, a server, and a user terminal. The in-vehicle device includes a display device, and an information processing device configured to output information via the display device. The display device includes a pair of displays provided in front of a driver's seat in a vehicle front-rear direction within a vehicle cabin, arranged at positions on a left side and a right side of a steering wheel while protruding backward in the vehicle front-rear direction from a meter portion disposed in front of the steering wheel, and including a touch panel. The information processing device includes a processor. The processor is configured to store information regarding an indicator displayed on the meter portion in a storage device, output to the display device, a command to display a screen in accordance with the information regarding the indicator stored in the storage device on the pair of displays, and transmit information for displaying a first screen on the user terminal, to the user terminal or the server. The first screen is a screen in accordance with the information regarding the indicator displayed on the meter portion.

A system according to a second aspect of the present disclosure includes a display device, and an information processing device configured to output information via the display device. The display device includes a pair of displays provided in front of a driver's seat in a vehicle front-rear direction within a vehicle cabin, arranged at positions on a left side and a right side of a steering wheel while protruding backward in the vehicle front-rear direction from a meter portion disposed in front of the steering wheel, and including a touch panel. The information processing apparatus includes a processor. The processor is configured to store information regarding an indicator displayed on the meter portion in a storage device, and output to the display device, a command to display a screen in accordance with the information regarding the indicator stored in the storage device on the pair of displays.

An information processing device according to a third aspect of the present disclosure is an information processing device that outputs information via a display device, and includes a processor. The display device includes a pair of displays provided in front of a driver's seat in a vehicle front-rear direction within a vehicle cabin, arranged at positions on a left side and a right side of a steering wheel while protruding backward in the vehicle front-rear direction from a meter portion disposed in front of the steering wheel, and including a touch panel. The processor is configured to store information regarding an indicator displayed on the meter portion in a storage device, and output to the display device, a command to display a screen in accordance with the information regarding the indicator stored in the storage device on the pair of displays.

Further, another aspect of the present disclosure is a vehicle equipped with the above-described system, an information processing method to be executed by the above-described information processing device, a program for causing a computer to execute the information processing method, or a computer-readable storage medium storing the program in a non-transitory manner.

According to the present disclosure, it is possible to make it easier for a user to confirm an indicator displayed in a vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view illustrating an inside of a vehicle cabin of a vehicle;

FIG. 2 is an enlarged view around a steering wheel;

FIG. 3 is a view schematically illustrating an example of a hardware configuration of the vehicle;

FIG. 4 is a view illustrating an example of a functional configuration of an ECU;

FIG. 5 is a view illustrating an example of a screen to be displayed on a meter display;

FIG. 6 is a view illustrating an example of a screen when description of content of an indicator is displayed on an outer display;

FIG. 7 is a view illustrating an example of a table configuration of a lighting information DB stored in a storage unit;

FIG. 8 is a flowchart of processing at the ECU when a description screen of the indicator is displayed on the outer display according to a first embodiment;

FIG. 9 is a view illustrating an example of a screen to be displayed on the outer display;

FIG. 10 is a view illustrating an example when description of the indicator is displayed on the outer display;

FIG. 11 is a view illustrating an example of a screen when lighting histories of the indicators are displayed on a map;

FIG. 12 is a flowchart of processing at the ECU when description of the indicator is displayed on the outer display according to a second embodiment;

FIG. 13 is a block diagram schematically illustrating an example of configurations of a vehicle, a user terminal, and a server that constitute a system according to a third embodiment;

FIG. 14 is a view illustrating an example of a screen when description of content of the indicator is displayed on a display of the user terminal;

FIG. 15 is a sequence diagram indicating processing of the entire system when information regarding the indicator is displayed on the user terminal according to the third embodiment; and

FIG. 16 is a flowchart of processing at an ECU when description of the indicator is displayed on the outer display according to a fourth embodiment.

### DETAILED DESCRIPTION OF EMBODIMENTS

A meter display of a vehicle includes an indicator such as a warning light and an indicator light for calling user's attention. This indicator is often represented with an abstract figure, and thus, there is a case where the user cannot recognize what kind of warning is issued even if the indicator is lighted. Further, some indicators are turned off after being lighted. If the indicator is turned off after being lighted, there is a case where the user cannot grasp which indicator has been lighted.

To address this problem, a system that is one aspect of the present disclosure is a system including a display device, and an information processing device that outputs information via the display device, and the display device being provided in front of a driver's seat within a vehicle cabin and including a pair of display units that is arranged at positions on both sides of a steering wheel while projecting to a rear side of a vehicle from a meter portion disposed in front of the steering wheel, and includes a touch panel.

The display device includes a pair of display units arranged at the positions on both sides of the steering wheel. Further, the pair of display units has a configuration that allows touch operation through the touch panel. The pair of display units is preferably arranged at positions that project to the rear side of the vehicle from the meter portion (typically, a meter panel in which a speed meter is arranged) disposed in front of the steering wheel, that is, positions closer to the driver in a front-rear direction of the vehicle. As a result of the pair of display units being provided at such positions, the touch panel can be arranged in the vicinity of a portion of the steering wheel, to be gripped by the driver. In other words, it is possible to minimize a period during which the driver releases his/her hand from the steering wheel upon operation. Note that the steering wheel does not necessary have to have a circular shape if the steering wheel has a gripping portion and performs steering operation by being rotated.

The pair of display units presents, for example, information related to control of the vehicle or information related to convenience of occupants of the vehicle to the user. The information related to convenience of the occupants of the vehicle may include information for providing entertainment to the occupants of the vehicle, information related to comfortability of the occupants, or the like. The information regarding comfortability and convenience of the occupants includes, for example, an interface for operating audio, navigation, an air conditioner, a phone, a watch, a voice assistant, or the like, and information regarding operating conditions of these kinds of equipment. Further, the information regarding control of the vehicle may include information regarding traveling of the vehicle. The information regarding control of the vehicle includes, for example, an interface for operating a headlight, a windshield wiper, a side mirror, an advanced driver assistance system (ADAS), a driving mode, a vehicle height, a position of the steering wheel, a position of a seat, or the like, and information regarding operating conditions of these kinds of equipment.

Here, the information processing device includes a control unit configured to execute storing information regarding an indicator displayed on the meter portion in a storage unit, and outputting to the display device, a command to display a screen in accordance with the information regarding the indicator stored in the storage unit on the pair of display units. The information regarding the indicator displayed on the meter portion includes at least information with which the lighted indicator can be determined. The screen in accordance with the information regarding the indicator may be a screen for displaying description corresponding to the indicator. On this screen, a text that describes content of the indicator may be displayed. Such a screen can be generated in accordance with the information stored in the storage unit even after the indicator is turned off. Thus, the user can confirm the indicator that has been lighted before even after the indicator has been turned off. Further, by the description of the indicator being displayed on the pair of display units, the user can determine what kind of points the user should watch out. Still further, the pair of display units is arranged closer to the user than the meter portion, and thus, the user can easily read the description when the description, and the like, are displayed. Note that it is only necessary that the above-described screen be displayed on one of the pair of display units.

Embodiments of the present disclosure will be described below based on the drawings. Configurations of the embodiments described below are examples, and the present disclosure is not limited to the configurations of the embodiments. Further, the embodiments described below can be combined wherever possible.

### First Embodiment

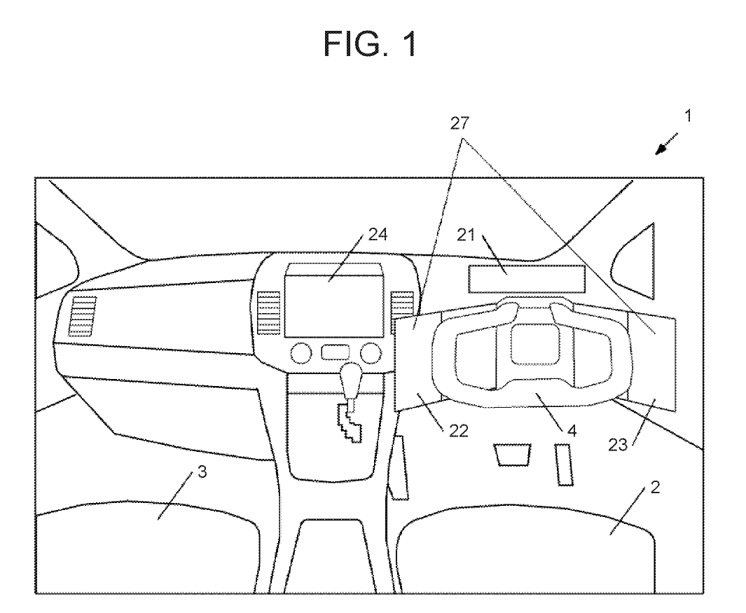

FIG. 1 is a view illustrating an inside of a vehicle cabin of a vehicle 1. As illustrated, a driver's seat 2 and a passenger's seat 3 are provided within the vehicle cabin of the vehicle 1. Note that the vehicle 1 in the present embodiment is a right-hand-drive vehicle, and the driver's seat 2 is provided on a right side of the vehicle. A steering wheel 4 is disposed in front of the driver's seat 2. Note that the steering wheel 4 may have a circular shape or may have a U shape (so-called non-round steering wheel) as illustrated. The steering wheel 4 is connected to a steering device of the vehicle 1 via a steering column. The steering column is covered with a column cover.

The passenger's seat 3 is provided leftward of the driver's seat 2, and a center display 24 is disposed on a front side of the vehicle at an intermediate position of the driver's seat 2 and the passenger's seat 3. For example, auxiliary information such as car navigation, content regarding entertainment such as audio and TV, or the like, is displayed on the center display 24.

A meter display 21 is provided on a front side of the vehicle from the steering wheel 4. The meter display 21 is a full screen type display located in front of the driver's seat 2 and providing various kinds of information to the driver of the vehicle 1. On the meter display 21, for example, information necessary for traveling of the vehicle such as a speed of the vehicle (vehicle speed), an engine speed (when the vehicle 1 has an engine), a charging and discharging condition (when the vehicle 1 has a drive battery), and a traveling distance is displayed. The meter display 21 is an example of the "meter portion" in the present disclosure.

A pair of display devices 27 is provided in front of the driver's seat 2 within the vehicle cabin. The pair of display devices 27 includes touch panel displays arranged at positions on both sides of the steering wheel 4. In the present embodiment, a display 22 arranged on an inner side of the vehicle will be referred to as an inner display 22, and a display 23 arranged on an outer side of the vehicle will be referred to as an outer display 23. The inner display 22 and the outer display 23 are connected to an instrument panel of the vehicle 1.

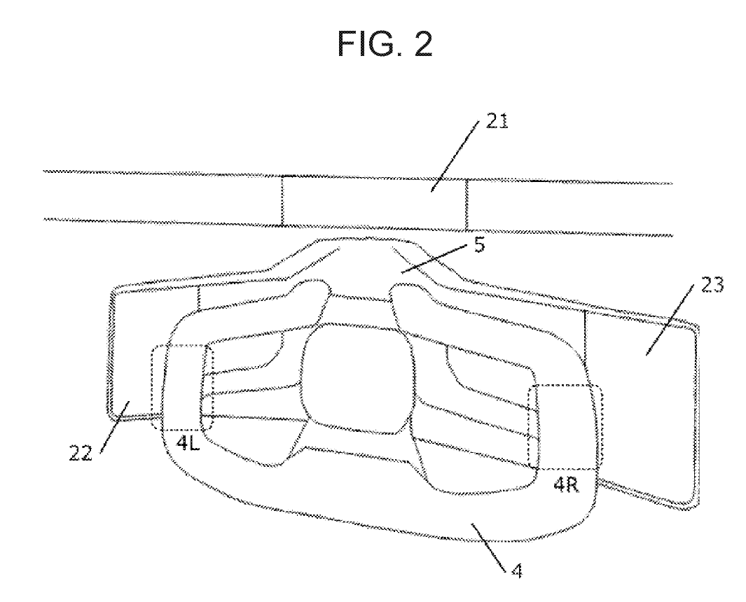

Detailed structures of the inner display 22 and the outer display 23 will be described with reference to FIG. 2. FIG. 2 is an enlarged view around the steering wheel 4. The inner display 22 and the outer display 23 are vertically long displays and connected to a support portion 5 that is a member supporting the displays. The support portion 5 has a shape projecting in a right-left direction of the steering wheel. The outer display 23 is connected to an end portion of the support portion 5 on the right side when viewed toward the front side of the vehicle, and the inner display 22 is connected to an end portion on the left side when viewed toward the front side of the vehicle. By this means, display surfaces can be arranged in the vicinity of the gripping portion of the steering wheel 4.

Note that the above description is an example in a case where the vehicle 1 is a right-hand-drive vehicle, and when the vehicle 1 is a left-hand-drive vehicle, the right side and the left side are reversed. In other words, the outer display 23 is connected to the end portion of the support portion 5 on the left side when viewed toward the front side of the vehicle, and the inner display 22 is connected to the end portion on the right side when viewed toward the front side of the vehicle.

The support portion 5 may be also used as the column cover that covers the steering column. The support portion 5 has a shape extending in the right-left direction (vehicle width direction) from a portion through which the steering column passes, the extending portions extending to the rear side of the vehicle and bending such that angles with respect to the right-left direction of the steering wheel 4 becomes smaller halfway.

Further, each of the inner display 22 and the outer display 23 is arranged to have an angle with respect to the right-left direction of the steering wheel and be inclined toward the steering wheel. In other words, a portion of the inner display 22 closer to the inner side of the vehicle 1 further projects to the rear side of the vehicle 1, and a portion of the outer display 23 closer to the outer side of the vehicle 1 further projects to the rear side of the vehicle 1. In this manner, each of the inner display 22 and the outer display 23 is arranged to face the driver.

A region 4R indicated with a dashed line in FIG. 2 is a portion (gripping portion) of the steering wheel 4 to be gripped with the right hand, and a region 4L indicated with a dashed line in FIG. 2 is a portion (gripping portion) of the steering wheel 4 to be gripped with the left hand. The inner display 22 and the outer display 23 are arranged on the front side of the vehicle from the gripping portions of the steering wheel 4 in the front-rear direction of the vehicle 1. As a result of the support portion 5 having the shape described above, positions of the inner display 22 and the outer display 23 in the vehicle front-rear direction can be made closer to the gripping portions of the steering wheel 4. It is therefore possible to make a movement amount of the hand smaller when the driver performs touch operation to the inner display 22 or the outer display 23 during driving.

The meter display 21, the inner display 22, and the outer display 23 are all displays including touch panels. Note that it is only necessary that at least the inner display 22 and the outer display 23 include the touch panels. As the touch panel, for example, a pressure sensitive touch panel that detects a pressure when the user presses the panel, and a capacitive touch panel that detects change of capacitance when the user presses the panel can be employed. The display is, for example, a liquid crystal display (LCD), an electroluminescence (EL) panel, or the like.

The inner display 22 displays, for example, information regarding convenience of the occupants of the vehicle 1. The information regarding convenience of the occupants of the vehicle 1 includes information for providing entertainment to the occupants of the vehicle 1. The information related to convenience of the occupants of the vehicle 1 may include information related to comfortability of the occupants, and the like. The information regarding comfortability and convenience of the occupants includes, for example, information regarding a switch, a button, and the like, for performing operation of audio, operation of a navigation device, operation of an air conditioner, operation of a phone, operation of a watch, operation of an AI partner (voice assistant), and the like, and information regarding operating conditions of these devices.

The outer display 23 displays, for example, information regarding control of the vehicle 1. The information regarding control of the vehicle 1 includes information regarding traveling of the vehicle 1. The information regarding control of the vehicle 1 includes, for example, information regarding a switch, a button, and the like, for performing operation of an electric window, operation of a headlight, operation of a windshield wiper, operation of a side mirror, operation of an ADAS, operation of a driving mode, operation of a suspension, operation of a position of the steering wheel, operation of a position of a seat, and the like, and information regarding operating conditions of these devices. By displaying the information regarding control of the vehicle 1 on the outer display 23, it is possible to prevent passengers other than the driver from operating the information regarding control of the vehicle 1.

Note that information to be displayed on the inner display 22 and the outer display 23 is not limited to the above. The inner display 22 may display the information regarding control of the vehicle 1, and the outer display 23 may display the information regarding convenience of the occupants of the vehicle 1. Further, the information to be displayed on the inner display 22 and the outer display 23 may be arbitrarily determined. Still further, as will be described later, information regarding the indicator displayed on the meter display 21 is displayed on the inner display 22 or the outer display 23.

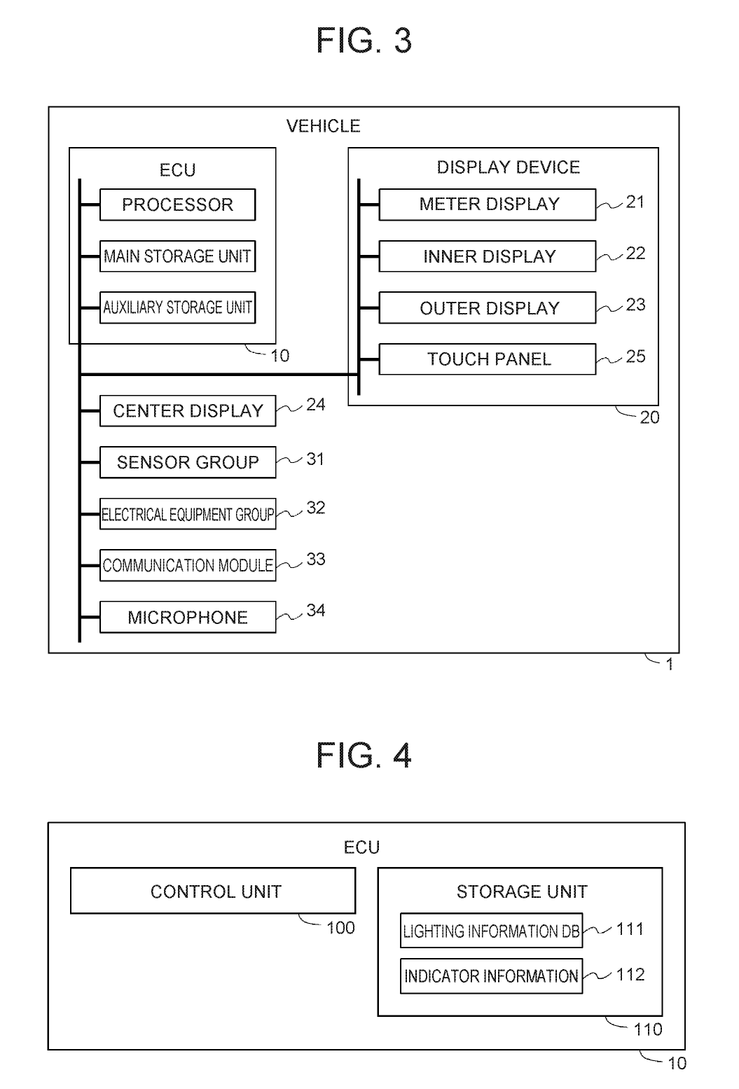

FIG. 3 is a view schematically illustrating an example of a hardware configuration of the vehicle 1. The vehicle 1 includes an ECU 10, a display device 20, a center display 24, a sensor group 31, an electrical equipment group 32, a communication module 33, and a microphone 34. The ECU 10 is constituted as a computer including a processor (such as a CPU and a GPU), a main storage device (such as a RAM and a ROM), and an auxiliary storage device (such as an EPROM, a hard disk drive and a removable medium). In the auxiliary storage device, an operating system (OS), various programs, various tables, and the like, are stored, and by the programs stored therein being executed, respective functions (software modules) that match predetermined purposes as will be described later can be implemented. However, some or all of the functions may be implemented as hardware modules by, for example, a hardware circuit such as an ASIC and an FPGA. To the ECU 10, the display device 20, the center display 24, the sensor group 31, the electrical equipment group 32, the communication module 33 and the microphone 34 are connected. The ECU 10 is an example of the information processing device.

The display device 20 includes the meter display 21, the inner display 22, the outer display 23, and the touch panel 25. The touch panel 25 is a unit for detecting touch operation performed on the meter display 21, the inner display 22, and the outer display 23. The touch panel 25 is arranged on each of the meter display 21, the inner display 22, and the outer display 23, thereby operation by touch can be performed.

The sensor group 31 is a group of a plurality of sensors for acquiring sensor data to be utilized in traveling of the vehicle 1. The sensor may be a sensor that acquires a physical amount or a sensor that acquires image data, and the like. The sensor group 31 includes, for example, a sensor that detects a state of the vehicle 1, a sensor that detects action of the driver, and the like. The sensor group 31 includes, for example, a speed sensor, an acceleration sensor, an accelerator operation amount sensor that detects a position of an accelerator pedal, a brake sensor that detects a position of a brake pedal, a steering wheel angle sensor that detects an angle of the steering wheel, an engine rotation speed sensor that detects a rotation speed of an engine, a coolant temperature sensor that detects a temperature of a coolant of the engine, an oil temperature sensor that detects a temperature of oil of the engine, an oil pressure sensor that detects a pressure of the oil of the engine, a sensor that detects an intake pressure of the engine, a yaw rate sensor, a direction indicator switch sensor (sensor that detects a state of a switch of the direction indicator), a shift position sensor, a sensor that detects position information (GPS sensor), a sensor that detects an in-vehicle temperature, a sensor that detects an outside temperature, a radar that measures a distance to an object, and the like.

The electrical equipment group 32 is a group of electrical equipment to be utilized in the vehicle 1. The electrical equipment group 32 can include an electric window, an air conditioner, a suspension, a massage seat, a navigation device, an audio device, a phone, a windshield wiper, a headlight, a side mirror, and a voice assistant.

The communication module 33 is communication means for connecting the vehicle 1 to a network. In the present embodiment, the vehicle 1 can perform communication with other devices (for example, an external server) by way of a network N1 by utilizing a mobile communication service such as 3G, LTE, 5G and 6G. The microphone 34 is means for acquiring utterance of the user and converts speech into an electric signal.

FIG. 4 is a view illustrating an example of a functional configuration of the ECU 10. The ECU 10 includes a control unit 100 and a storage unit 110 as functional components. The control unit 100 is, for example, a functional component provided by the processor executing various programs stored in an auxiliary storage unit. The storage unit 110 is means for storing information and includes a main storage unit and the auxiliary storage unit. The storage unit 110 includes a storage device. In the storage unit 110, a lighting information database 111 (hereinafter, referred to as a lighting information DB 111), and indicator information 112 are stored.

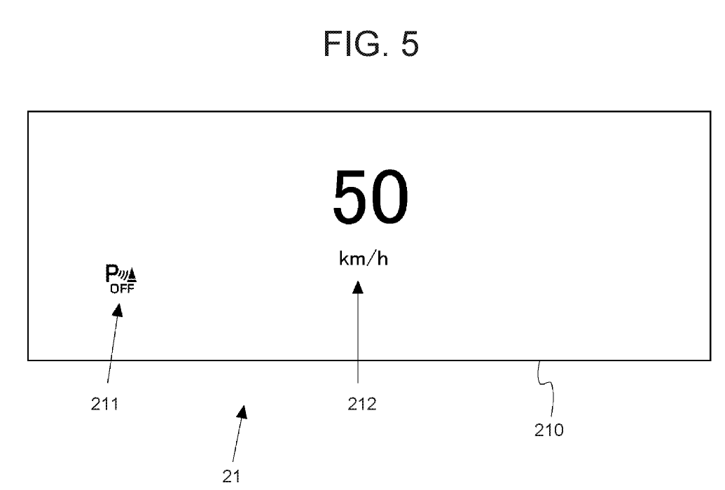

The control unit 100 generates screens to be displayed on the meter display 21, the inner display 22, and the outer display 23. FIG. 5 is a view illustrating an example of a screen 210 to be displayed on the meter display 21. For example, a vehicle speed 212, and an indicator 211 such as a warning light or an indicator light are displayed on the meter display 21. In the example illustrated in FIG. 5, a clearance sonar OFF warning light is displayed as the indicator 211. Note that indicator 211 is not limited to the clearance sonar OFF warning light. For example, a brake warning light, a high coolant temperature warning light, a charging warning light, an oil pressure warning light, an engine warning light, an SRS airbag/pretensioner warning light, an ABS & brake assist warning light, a pedal erroneous operation warning light, a power steering warning light, a low fuel warning light, a seatbelt unfastened warning light, a rear seatbelt unfastened warning light, a tire pressure warning light, a pre-crash safety warning light, a lane tracing assist warning light, a lane departure alert indicator light, a cruise control indicator light, a radar cruise control indicator light, a proactive driving assist indicator light, a driver assistance information indicator light, a slip indicator light, a parking brake indicator light, and a brake hold actuation indicator light, and the like, are displayed on the meter display 21. The control unit 100 transmits a command to display the indicator 211 to the meter display 21 when each of conditions for lighting these indicators 211 is satisfied.

Here, the indicator 211 is often represented with an abstract figure. Thus, even if the indicator 211 is displayed on the meter display 21, there is a case where the user doesn't understand what is represented by the indicator 211. Thus, the user needs to check what is indicated by the indicator 211 through instructions manual, web search, or the like.

Thus, the control unit 100 outputs information for describing content of the indicator 211 to the user. To implement this, the control unit 100 stores the indicator 211 displayed on the meter display 21 in the lighting information DB 111 of the storage unit 110. Then, the control unit 100 displays a text that describes what is represented by the indicator 211 on the inner display 22 or the outer display 23 in response to an inquiry from the user. Note that description will be provided below assuming that the text for description is displayed on the outer display 23.

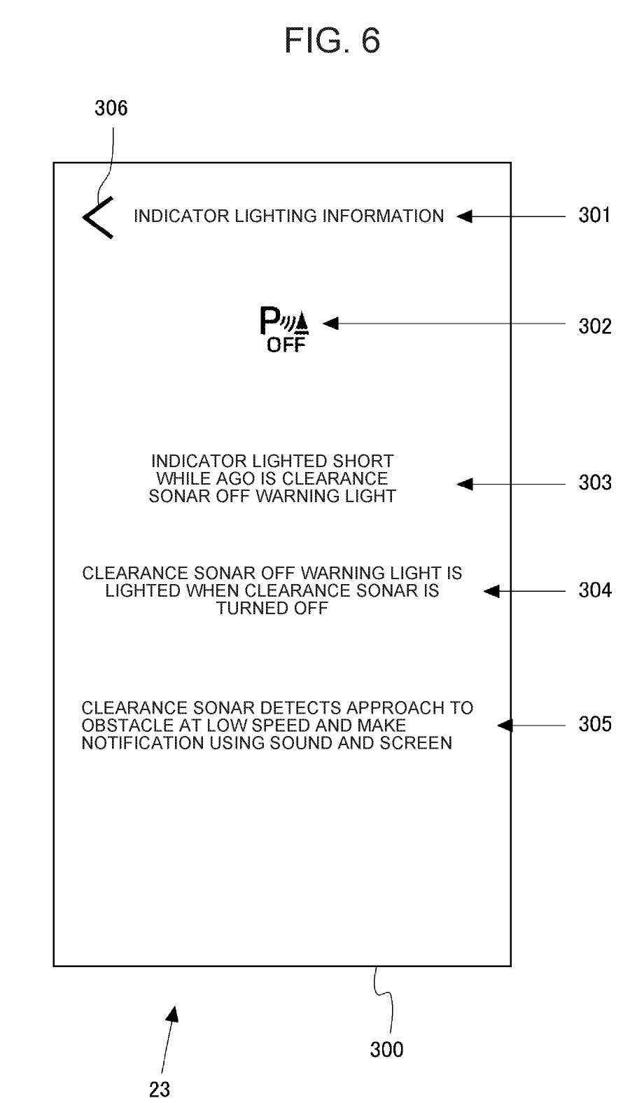

When the microphone 34 receives a predetermined input, the control unit 100 displays, for example, a text for describing content of the indicator 211 on the outer display 23. The predetermined input is, for example, an inquiry about the indicator 211 such as "what is the warning issued a short while ago" and "what was lighted a short while ago". Utterance corresponding to this predetermined input is stored in the storage unit 110. FIG. 6 is a view illustrating an example of a screen when the description of the content of the indicator 211 is displayed on the outer display 23. In FIG. 6, a reference numeral 301 indicates a text that describes that the screen is a screen 300 for the indicator lighting information. A reference numeral 302 indicates the indicator 211 displayed on the meter display 21 immediately prior. A reference numeral 303 indicates a text that describes name of the indicator 211 lighted immediately prior. A reference numeral 304 indicates a text that describes a lighting condition of the indicator 211. A reference numeral 305 indicates a text that describes a function of equipment corresponding to the indicator 211. The texts indicated by the reference numerals 303, 304, and 305 corresponding to the respective indicators 211 are stored in the storage unit 110 as the indicator information 112. A reference numeral 306 indicates a graphical user interface (GUI) part for returning to a screen before the indicator lighting information is displayed, a home screen or a menu screen.

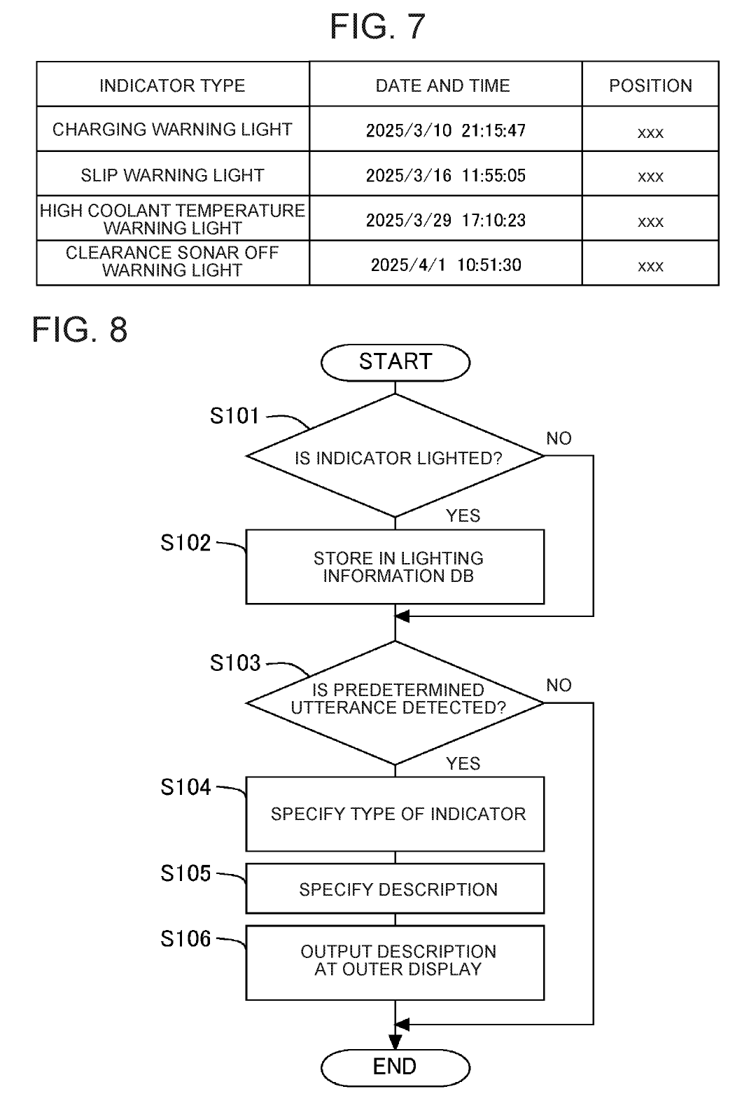

FIG. 7 is a view illustrating an example of a table configuration of the lighting information DB 111 stored in the storage unit 110. The lighting information DB 111 is a database that stores information regarding display histories of the indicators 211. The lighting information DB 111 has an indicator type field, a date and time field, and a position field. In the indicator type field, information regarding the indicator 211 displayed on the meter display 21 is stored. Here, the control unit 100 outputs a command to light the indicator 211 to the meter display 21 when a signal from the sensor group 31 satisfies a predetermined condition. The predetermined condition is stored in the storage unit 110 for each indicator 211 as the indicator information 112. The control unit 100 stores a type of the indicator 211 in the indicator type field of the lighting information DB 111 when the indicator 211 is lighted. Further, the control unit 100 acquires information regarding date and time at which the indicator 211 has been lighted via, for example, a GPS sensor or the communication module 33 and stores the information in the date and time field. Further, the control unit 100 acquires position information when the indicator 211 has been lighted via, for example, a GPS sensor or the communication module 33 and stores the position information in the position field.

FIG. 8 is a flowchart of processing at the ECU 10 when a description screen of the indicator 211 is displayed on the outer display 23 according to the first embodiment. The processing indicated in FIG. 8 is repeatedly executed every predetermined period at the ECU 10.

In step S101, the control unit 100 determines whether the indicator 211 is lighted at the meter display 21. The control unit 100 determines which of the indicators 211 is to be lighted in accordance with a signal from the sensor group 31. Then, when the control unit 100 determines that there is the indicator 211 to be lighted, the control unit 100 transmits a command to display the corresponding indicator 211 to the meter display 21. In this manner, when the command to display the indicator 211 is transmitted to the meter display 21, the control unit 100 makes a positive determination in step S101. When the control unit 100 makes a positive determination in step S101, the processing proceeds to step S102, and when the control unit 100 makes a negative determination, the processing proceeds to step S103.

In step S102, the control unit 100 stores information regarding each of the indicator type, date and time and the position in the lighting information DB 111. The display histories are arranged in chronological order in the lighting information DB 111. When the processing in step S102 is completed, the processing proceeds to step S103.

In step S103, the control unit 100 determines whether predetermined utterance has been detected. The predetermined utterance is utterance regarding a question for the indicator 211 from the user. In this event, the control unit 100 may determine, for example, whether the microphone 34 receives an input including a predetermined keyword. When the utterance of the user includes the predetermined keyword stored in the storage unit 110, the control unit 100 determines that the predetermined utterance has been detected. Note that when the user has a dialogue with a virtual agent (AI partner) capable of having a dialogue using natural language, the control unit 100 may determine whether there is an input including a predetermined keyword. For example, a character of a virtual agent is displayed on the inner display 22 or the outer display 23, and the user can ask a question for the indicator 211 by having a dialogue with the character. A dialogue service using natural language is provided by the control unit 100. In step S103, when the control unit 100 makes a positive determination, the processing proceeds to step S104, and when the control unit 100 makes a negative determination, the present routine ends.

In step S104, the control unit 100 specifies the indicator 211 lighted last. The control unit 100 specifies a record of the indicator 211 lighted recently from the lighting information DB 111 and specifies a type of the indicator 211 in accordance with the information stored in the indicator type field. When the processing in step S104 is completed, the processing proceeds to step S105.

In step S105, the control unit 100 specifies description of the indicator 211. The control unit 100 specifies the description of the indicator 211 from the indicator information 112 in accordance with the type of the indicator 211 specified in step S104. When the processing in step S105 is completed, the processing proceeds to step S106.

In step S106, the control unit 100 generates a screen 300 for the indicator lighting information as illustrated in FIG. 6 in accordance with the description specified in step S105 and outputs the screen 300. In this event, the control unit 100 transmits a command to display the screen 300 for the indicator lighting information on the outer display 23, to the outer display 23.

As described above, according to the present embodiment, it is possible to display the description of the indicator 211 displayed on the meter display 21 in the past, on the inner display 22 or the outer display 23. Further, the display histories of the indicators 211 are stored, and thus, the user can confirm the indicators 211 displayed in the past. This allows the user to confirm later the indicator 211 with what kind of content is displayed.

### Second Embodiment

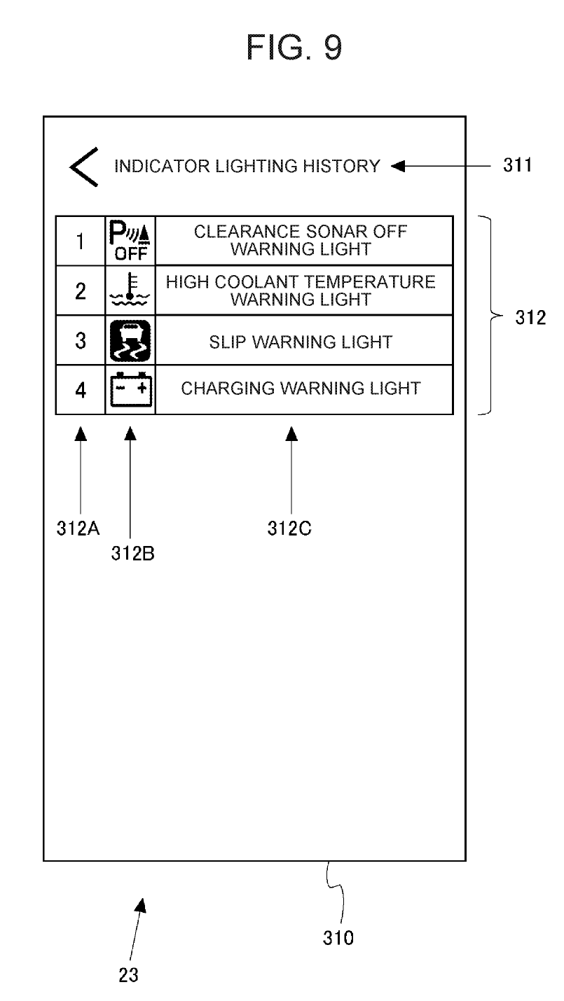

In a second embodiment, description regarding the indicator selected by the user from lighting histories of the indicators is displayed. In this event, the control unit 100 outputs to the outer display 23, a command to display the lighting histories of the indicators on the outer display 23. FIG. 9 is a view illustrating an example of a screen to be displayed on the outer display 23. The screen illustrated in FIG. 9 may be displayed when a predetermined GUI part is touched on the home screen or the menu screen or may be displayed when a predetermined keyword is input to the microphone 34. The predetermined GUI part is a GUI part for moving to a screen 310 that displays the lighting histories of the indicators. The predetermined keyword is a keyword regarding the display histories of the indicators 211 such as, for example, "show histories of the warning lights" and "what is the warning a short while ago", and is stored in the storage unit 110. In FIG. 9, a reference numeral 311 indicates a text that describes that the screen is the screen regarding the lighting histories of the indicators, a reference numeral 312 indicates a table in which the display histories of the indicators 211 are arranged in reverse chronological order. A reference numeral 312A indicates the order when the display histories of the indicators 211 are arranged in reverse chronological order. A reference numeral 312B indicates the indicator 211 displayed on the meter display 21. A reference numeral 312C indicates name of the indicator 211.

The control unit 100 arranges the indicators 211 displayed on the meter display 21 in reverse chronological order and displays the indicators 211 on the outer display 23. The control unit 100 extracts information regarding types of the indicators in reverse chronological order from a current time point from the indicator type field of the lighting information DB 111 and arranges the information as indicated with the reference numeral 312C. Further, the control unit 100 extracts figures corresponding to the types of the indicators from the indicator information 112 and arranges the figures as indicated with the reference numeral 312B. Note that in the example illustrated in FIG. 9, histories of the clearance sonar OFF warning light, the high coolant temperature warning light, the slip warning light, and the charging warning light are arranged in this order from the top in the table indicated with the reference numeral 312. The clearance sonar OFF warning light is a warning light that is lighted when a clearance sonar is turned OFF. The high coolant temperature warning light is a warning light that is lighted when a high temperature abnormality of an engine coolant is detected. The slip warning light is a warning light that is lighted when an abnormality of a system that suppresses slip is detected. The charging warning light is a warning light that is lighted when an abnormality of a charging system is detected.

The "clearance sonar OFF warning light" displayed at the top of the table indicated with the reference numeral 312 is name of the indicator 211 displayed recently on the meter display 21. When the user touches the display history of the indicator 211 displayed in FIG. 9, description corresponding to a row touched by the user is displayed on the outer display 23. In this event, the control unit 100 specifies a position touched by the user from a touch signal from the touch panel 25. A relationship between a position in the table indicated with the reference numeral 312 displayed on the touch panel and the corresponding indicator 211 is stored in the storage unit 110. The control unit 100 displays description corresponding to the specified indicator 211 on the outer display 23 in accordance with the indicator information 112. Note that the control unit 100 may further display, date and time and the position when the indicator 211 has been lighted, on the screen 310 that displays the lighting histories of the indicators illustrated in FIG. 9 using the information stored in the lighting information DB 111.

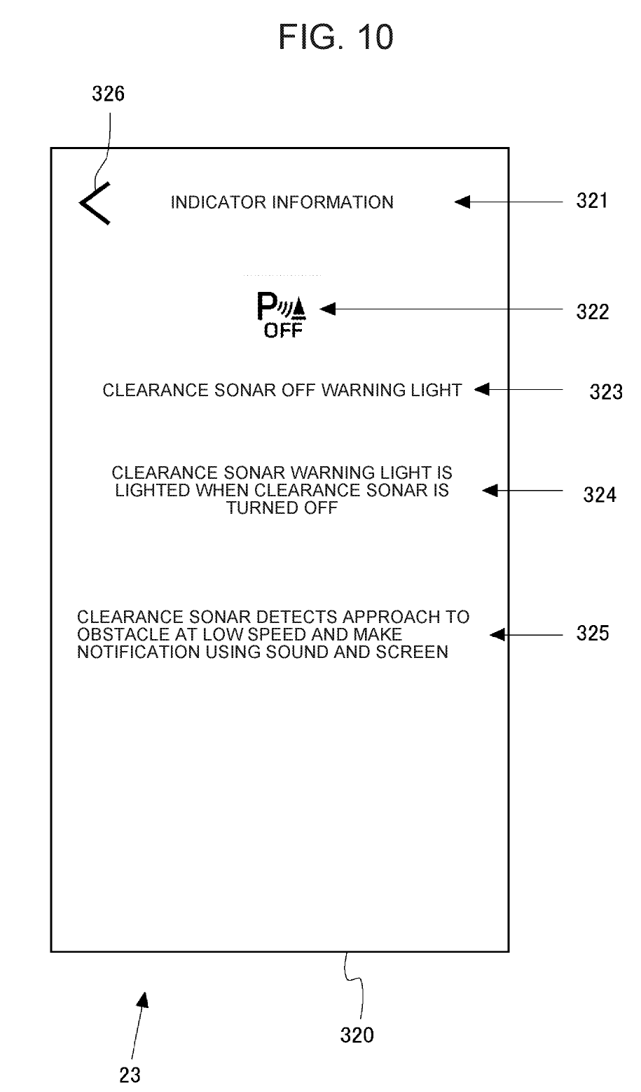

FIG. 10 is a view illustrating an example of a screen when the description of the indicator 211 is displayed on the outer display 23. In FIG. 10, a reference numeral 321 indicates a text that describes that the screen is a screen 320 for the indicator information. A reference numeral 322 indicates the indicator 211 corresponding to the row touched by the user in the table indicated with the reference numeral 312 in FIG. 9. A reference numeral 323 indicates a text that describes name of the indicator 211 touched by the user. A reference numeral 324 indicates a text that describes a lighting condition of the indicator 211. A reference numeral 325 indicates a text that describes a function of equipment corresponding to the indicator 211. The texts indicated with the reference numerals 323, 324, and 325 corresponding to the respective indicators 211 are stored in the storage unit 110 as the indicator information 112. A reference numeral 326 indicates a GUI part for returning to the screen 310 that displays the lighting histories of the indicators.

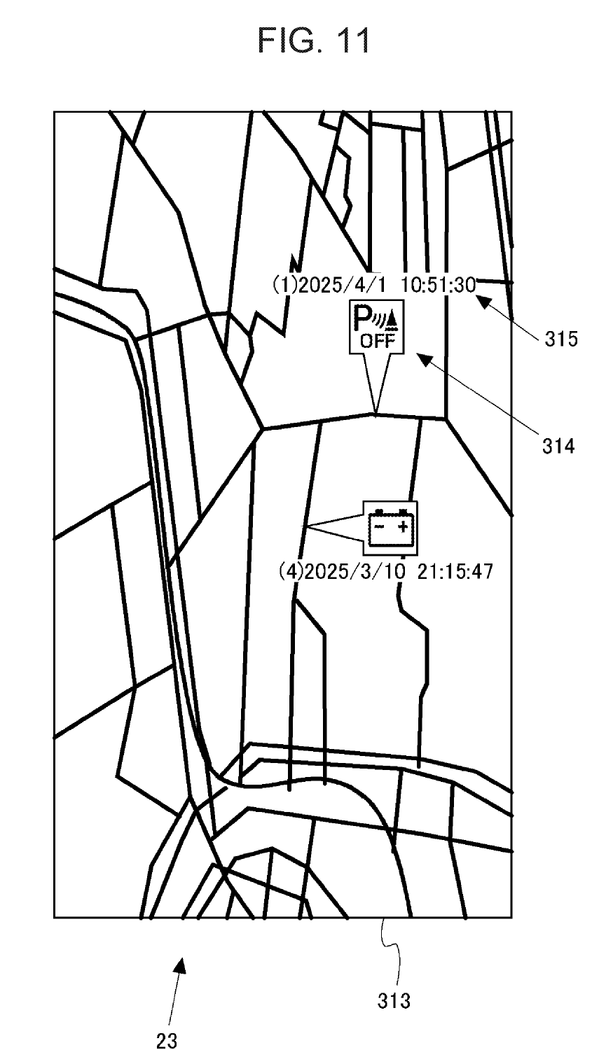

Note that the screen indicating the lighting histories of the indicators displayed on the outer display 23 is not limited to the screen illustrated in FIG. 9. For example, FIG. 11 is a view illustrating an example of a screen 313 when the lighting histories of the indicators are displayed on a map. In FIG. 11, a reference numeral 314 indicates a position when the indicator 211 has been displayed on the map, and the corresponding indicator 211 is displayed. Further, a reference numeral 315 indicates a text indicating reverse chronological order of display of the indicator 211, and a text indicating date and time at which the indicator 211 has been displayed. By the user touching the indicator 211 indicated with the reference numeral 314, the screen 320 for describing the indicator 211 as illustrated in FIG. 10 may be displayed on the outer display 23. Further, the table indicated with the reference numeral 312 in FIG. 9 and the map illustrated in FIG. 11 may be displayed on the same screen.

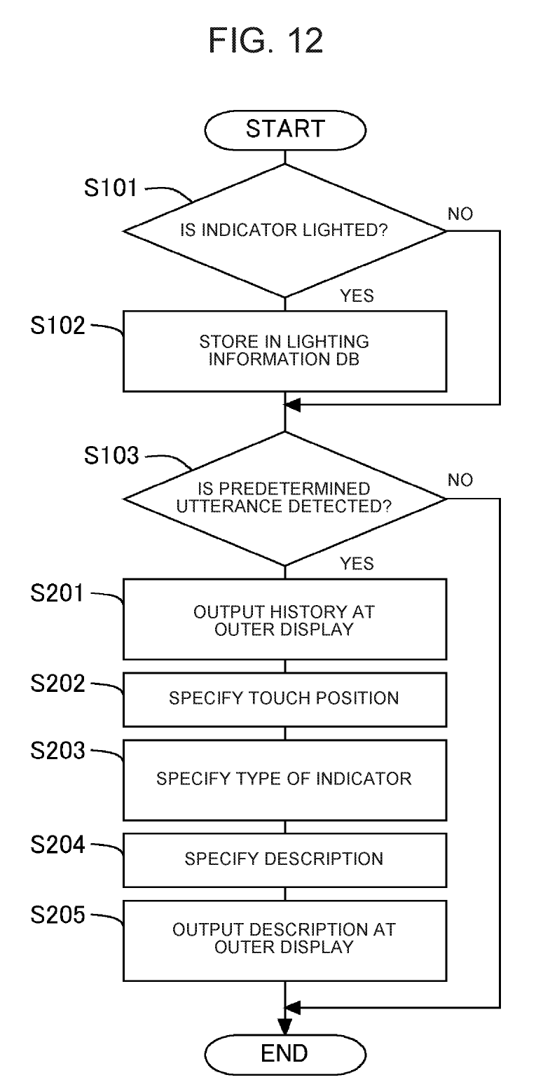

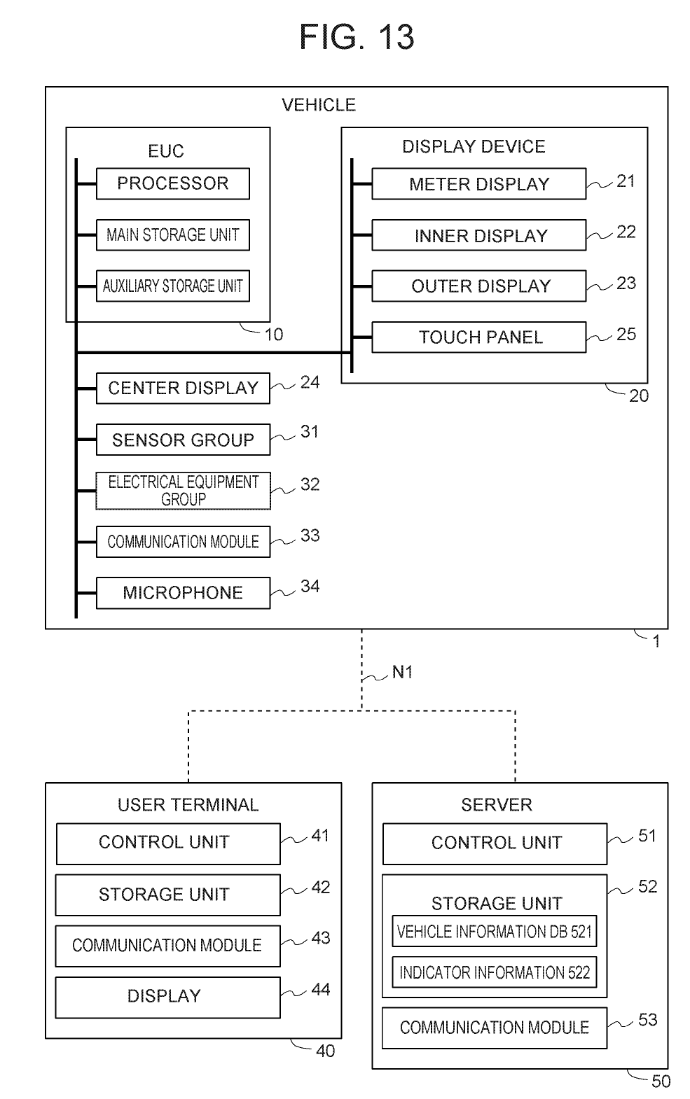

FIG. 12 is a flowchart of processing at the ECU 10 when the description of the indicator 211 is displayed on the outer display 23 according to the second embodiment. The processing indicated in FIG. 12 is repeatedly executed every predetermined period at the ECU 10. In the flowchart indicated in FIG. 12, step in which processing that is the same as the processing indicated in FIG. 8 is executed will be denoted by the same reference numeral and description will be omitted.

In the flowchart indicated in FIG. 12, when the control unit 100 makes a positive determination in step S103, the processing proceeds to step S201. In step S201, the control unit 100 generates the screen 310 that displays the lighting histories of the indicators as illustrated in FIG. 9 in accordance with the information stored in the lighting information DB 111 and outputs the screen 310. In this event, the control unit 100 transmits to the outer display 23, a command to display the screen 310 that displays the lighting histories of the indicators on the outer display 23.

In step S202, the control unit 100 specifies a position touched by the user in accordance with a touch signal received from the touch panel 25. Further, in step S203, the control unit 100 specifies a type of the indicator touched by the user in accordance with the position touched by the user. A relationship between the position on the touch panel 25 and the type of the indicator may be stored in the storage unit 110. In step S204, the control unit 100 specifies description of the indicator 211. The control unit 100 specifies the description of the indicator 211 from the indicator information 112 in accordance with the type of the indicator 211 specified in step S203. If the processing in step S204 is completed, the processing proceeds to step S205.

In step S205, the control unit 100 generates the screen 320 for the indicator information as illustrated in FIG. 10 in accordance with the description specified in step S204 and outputs the screen 320. In this event, the control unit 100 transmits to the outer display 23, a command to display the screen 320 for the indicator information on the outer display 23.

In this manner, the user can select the indicator 211 that the user desires to check from histories of the indicators 211 displayed on the meter display 21 in the past. Then, the description of the indicator 211 selected by the user can be provided to the user.

### Third Embodiment

FIG. 13 is a block diagram schematically illustrating an example of configurations of the vehicle 1, the user terminal 40, and the server 50 that constitute a system according to a third embodiment. While in the first embodiment and the second embodiment, the control unit 100 displays the content and the histories of the indicators 211 on the outer display 23, in the present embodiment, the content and the histories of the indicators 211 are further displayed on the user terminal 40.

The user terminal 40 is a terminal to be used by the user of the vehicle 1, and is, for example, a smartphone, a tablet terminal, a wearable terminal, a personal computer (PC), or the like. For example, application software capable of receiving a notification from the vehicle 1 or the server 50 is installed in the user terminal 40. The user terminal 40 includes a control unit 41, a storage unit 42, a communication module 43, and a display 44. The control unit 41 of the user terminal 40 can be implemented by, for example, a hardware processor such as a CPU. Further, the control unit 41 may include a RAM, a read only memory (ROM), a cache memory, and the like. The storage unit 42 is means for storing information and includes a storage medium such as a RAM, a magnetic disk, and a flash memory. In the storage unit 42, programs to be executed at the control unit 41, data to be utilized by the programs, and the like, are stored. The communication module 43 of the user terminal 40 has a configuration similar to the configuration of the communication module 13 of the vehicle 1. Note that the communication module 13 of the vehicle 1 and the communication module 43 of the user terminal 40 may include, for example, a wireless communication interface for performing near field communication such as Bluetooth (registered trademark). Further, the vehicle 1 and the user terminal 40 may be configured such that the vehicle 1 and the user terminal 40 can perform near field communication. The display 44 is means for presenting information to the user, and is, for example, a liquid crystal display (LCD), an electroluminescence (EL) panel, or the like. The display 44 may be constituted as a touch screen including a touch panel.

When the control unit 41 of the user terminal 40 receives information from the vehicle 1 or the server 50, the control unit 41 displays an image in accordance with the information on the display 44. For example, when a command to display the indicator lighting information is received from the server 50, the control unit 41 displays an image in accordance with the indicator lighting information on the display 44.

The server 50 can be constituted as a computer including a processor (such as a CPU and a GPU), a main storage device (such as a RAM and a ROM), and an auxiliary storage device (such as an EPROM, a hard disk drive and a removable medium). In the auxiliary storage device, an operating system (OS), various programs, various tables, and the like, are stored, and by the programs stored therein being executed, respective functions (software modules) that match predetermined purposes as will be described later can be implemented. However, some or all of the modules may be implemented by, for example, a hardware circuit such as an ASIC and an FPGA as hardware modules.

The server 50 includes a control unit 51, a storage unit 52, and a communication module 53. The control unit 51 is an arithmetic unit that implements various functions of the server 50 by executing predetermined programs. The control unit 51 can be implemented by, for example, a hardware processor such as a CPU. Further, the control unit 51 may include a RAM, a ROM, a cache memory, and the like.

When the control unit 51 receives lighting information from the vehicle 1, the control unit 51 updates a vehicle information DB 521 which will be described later in accordance with the lighting information. Further, the control unit 51 specifies the user terminal 40 corresponding to the vehicle 1 that has transmitted the lighting information and transmits to the user terminal 40, a command to display information corresponding to the lighting information on the display 44 of the user terminal 40.

The storage unit 52 is means for storing information and includes a RAM, a magnetic disk, a flash memory, and the like. In the storage unit 52, programs to be executed at the control unit 51, data to be utilized by the programs, and the like, are stored. Further, in the storage unit 52, a database (vehicle information DB 521) is constructed. Still further, in the storage unit 52, indicator information 522 that is information regarding the indicator is stored.

The vehicle information DB 521 is a database generated for each vehicle 1. The vehicle information DB 521 has a vehicle ID field, a user terminal ID field, and a lighting information field. In the vehicle ID field, information (vehicle ID) with which the vehicle 1 can be identified is stored. In the user ID field, information (user terminal ID) with which the user terminal 40 of the user of the vehicle 1 can be identified is stored. In the lighting information, the lighting information received from the vehicle 1 is stored. The lighting information is information that is the same as the information stored in the lighting information DB 111 of the vehicle 1.

The communication module 53 is a communication interface for connecting the server 50 to the network N1. The communication module 53 includes, for example, a network interface board, a wireless communication interface for wireless communication, and the like. The server 50 can perform data communication with the vehicle 1 and the user terminal 40 via the communication module 53.

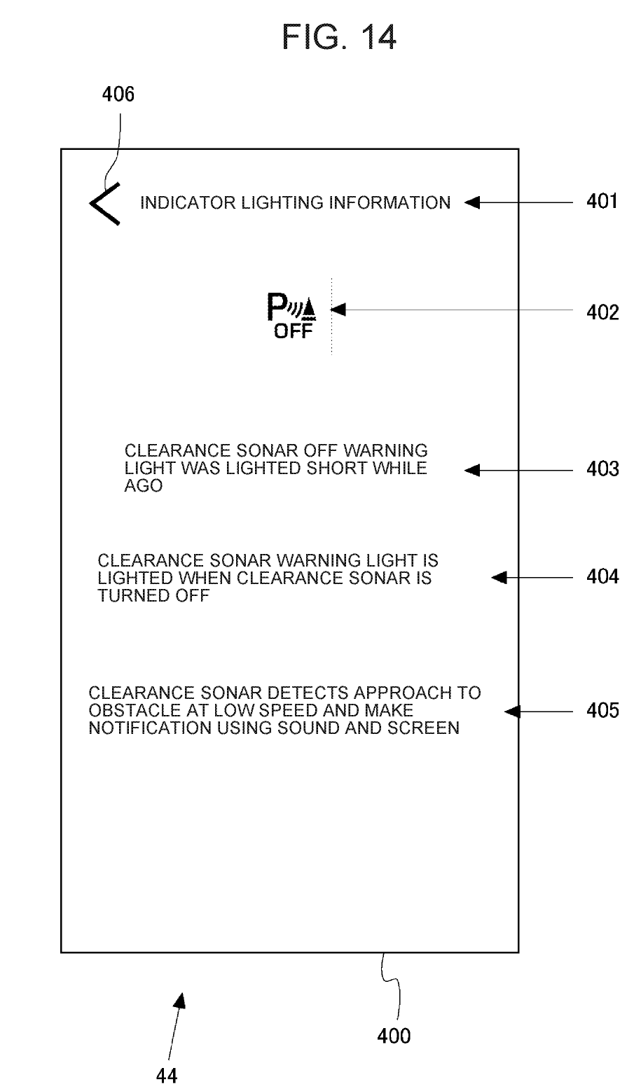

FIG. 14 is a view illustrating an example of a screen when description of content of the indicator 211 is displayed on the display 44 of the user terminal 40. In FIG. 14, a reference numeral 401 indicates a text that describes that the screen is a screen 400 for the indicator lighting information. A reference numeral 402 indicates the indicator 211 displayed on the meter display 21 immediately prior. A reference numeral 403 indicates a text that describes name of the indicator 211 lighted immediately prior. A reference numeral 404 indicates a text that describes a lighting condition of the indicator 211. A reference numeral 405 indicates a text that describes a function of equipment corresponding to the indicator 211. The texts indicated with the reference numerals 403, 404, and 405 corresponding to the respective indicators 211 are stored in the storage unit 52 of the server 50 as the indicator information 522. A reference numeral 406 is a GUI part for returning to a screen before the screen 400 for the indicator lighting information is displayed or a screen upon start of an application.

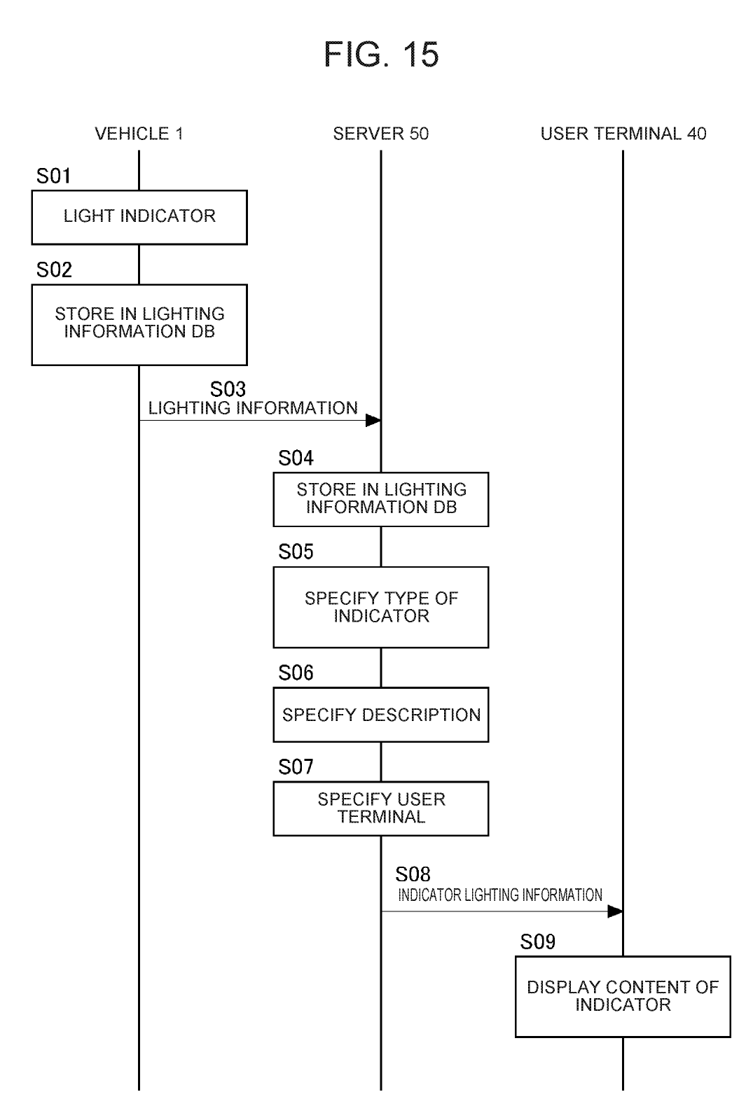

FIG. 15 is a sequence diagram indicating processing of the entire system when information regarding the indicator 211 is displayed on the user terminal 40 according to the third embodiment. First, the indicator 211 is lighted in the vehicle 1 (S01). When the control unit 100 of the vehicle 1 lights the indicator, the control unit 100 stores information regarding each of an indicator type, date and time, and a position in the lighting information DB 111 (S02). The information is arranged in chronological order in the lighting information DB 111.

Further, the control unit 100 of the vehicle 1 transmits lighting information to the server 50 (S03). The lighting information includes information on the type of the indicator 211 lighted recently on the meter display 21 by the control unit 100, date and time at which the indicator 211 has been lighted, and a position when the indicator 211 has been lighted. In this event, the control unit 100 specifies the indicator 211 lighted last. The control unit 100 specifies a record of the indicator 211 lighted recently from the lighting information DB 111 and specifies the type of the indicator 211, the date and time at which the indicator 211 has been lighted, and the position of the vehicle 1 when the indicator 211 has been lighted in accordance with the information stored in the indicator type field. Then, the control unit 100 of the vehicle 1 transmits the lighting information in association with the vehicle ID to the server 50.

When the control unit 51 of the server 50 receives the lighting information from the vehicle 1, the control unit 51 stores the lighting information in the vehicle information DB 521 (S04). Note that the user terminal ID associated with the vehicle ID may be registered in advance in the server 50 by the user.

The control unit 51 of the server 50 specifies the type of the indicator 211 in accordance with the lighting information stored in the vehicle information DB 521 (S05). Further, the control unit 51 of the server 50 specifies description of the indicator 211 in accordance with the type of the indicator 211 (S06). The description in accordance with the type of the indicator 211 is acquired from the indicator information 522 stored in the storage unit 52.

Further, the control unit 51 of the server 50 specifies the user terminal 40 in accordance with the vehicle information DB 521 (S07). Still further, the control unit 51 of the server 50 transmits indicator lighting information to the specified user terminal 40 (S08). The indicator lighting information includes information regarding the screen 400 for the indicator lighting information as illustrated in FIG. 14, and a command to display the screen 400 on the display 44 of the user terminal 40. In this event, the control unit 51 generates the screen 400 for the indicator lighting information as illustrated in FIG. 14 in accordance with the specified description and transmits the screen 400 to the user terminal 40.

The control unit 41 of the user terminal 40 that has received the indicator lighting information displays the screen 400 for the indicator lighting information on the display 44 (S09). In this manner, the description for the indicator 211 can be displayed on the display 44 of the user terminal 40. Note that the control unit 51 of the server 50 may transmit to the user terminal 40, a command to display the screen 310 that displays the lighting histories of the indicators as illustrated in FIG. 9 on the display 44 of the user terminal 40. Then, the control unit 41 of the user terminal 40 may transmit information regarding the indicator corresponding to a row touched by the user in the table indicated with the reference numeral 312 in FIG. 9 to the server 50. Further, the control unit 51 of the server 50 may transmit to the user terminal 40, a command to display the screen 320 for the indicator information corresponding to the indicator on the display 44.

As described above, according to the present embodiment, the user can confirm the description of the indicator 211 by utilizing the user terminal 40.

### Fourth Embodiment

While in the third embodiment, the control unit 51 of the server 50 displays the description of the indicator 211 on the display 44 of the user terminal 40, the control unit 100 of the vehicle 1 can display the description of the indicator 211 on the display 44 of the user terminal 40 by the vehicle 1 and the user terminal 40 performing near field communication.

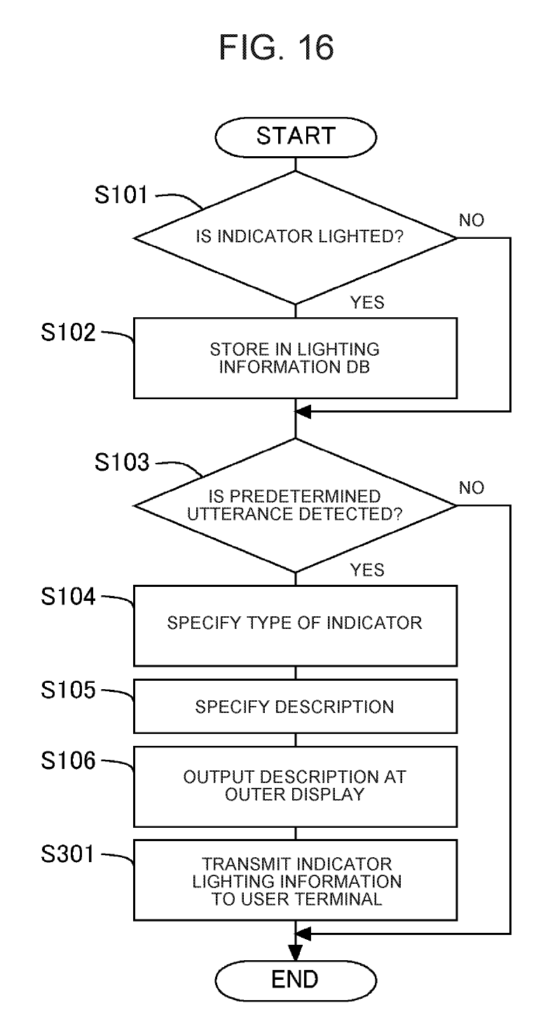

FIG. 16 is a flowchart of processing at the ECU 10 when the description of the indicator 211 is displayed on the outer display 23 according to the fourth embodiment. The processing indicated in FIG. 16 is repeatedly executed every predetermined period at the ECU 10. In the flowchart indicated in FIG. 16, step in which processing that is the same as the processing indicated in FIG. 8 is executed will be denoted by the same reference numeral and description will be omitted.

In the flowchart indicated in FIG. 16, when the processing of step S106 is completed, the processing proceeds to step S301. In step S301, the control unit 100 transmits indicator lighting information to the user terminal 40. The indicator lighting information includes information regarding the screen 400 for the indicator lighting information as illustrated in FIG. 14, and a command to display the screen 400 on the display 44 of the user terminal 40. In this event, the control unit 100 generates the screen 400 for the indicator lighting information as illustrated in FIG. 14 in accordance with the specified description and transmits the screen 400 to the user terminal 40. The control unit 41 of the user terminal 40 that has received the indicator lighting information displays the screen 400 for the indicator lighting information on the display 44.

Note that the control unit 100 of the vehicle 1 may transmit to the user terminal 40, a command to display the screen 310 that displays the lighting histories of the indicators as illustrated in FIG. 9 on the display 44 of the user terminal 40. Then, the control unit 41 of the user terminal 40 may transmit information regarding the indicator corresponding to the row touched by the user in the table indicated with the reference numeral 312 in FIG. 9 to the vehicle 1. Further, the control unit 100 of the vehicle 1 may transmit to the user terminal 40, a command to display the screen 320 for the indicator information corresponding to the indicator on the display 44.

As described above, according to the present embodiment, the user can confirm the description of the indicator 211 by utilizing the user terminal 40.

### Other Embodiments

The above-described embodiments are merely an example and can be implemented with changes made as appropriate within the scope not deviating from the gist of the present disclosure. Further, the processing and means described in the present disclosure can be freely combined and implemented unless technical inconsistencies arise. Further, the processing described as being performed by one device may be shared and executed by a plurality of devices. Alternatively, the processing described as being performed by different devices may be executed by one device. In a computer system, what kind of hardware configuration is used to implement each function can be flexibly changed.

The present disclosure can be implemented also by supplying a computer program that implements the functions described in the above-described embodiment to a computer, and one or more processors of the computer reading and executing the program. Such a computer program may be provided to the computer by a non-transitory computer-readable storage medium which is connectable to a system bus of the computer or may be provided to the computer via a network. The non-transitory computer-readable storage medium includes, for example, an arbitrary type of disk such as a magnetic disk (such as a Floppy (registered trademark) disk or a hard disk drive (HDD)) and an optical disk (such as a CD-ROM, a DVD disk or a Blu-ray disc) and an arbitrary type of medium appropriate for storing an electronic command, like a read only memory (ROM), a random access memory (RAM), an EPROM, an EEPROM, a magnetic card, a flash memory or an optical card.

What is claimed is:

1. A system comprising:
an in-vehicle device that includes a display device, and an information processing device configured to output information via the display device;
a server; and
a user terminal, wherein:
the display device includes a pair of displays provided in front of a driver's seat in a vehicle front-rear direction within a vehicle cabin, arranged on a left side and a right side of a steering wheel while protruding backward in the vehicle front-rear direction from a meter portion disposed in front of the steering wheel, and including a touch panel; and
the information processing device includes a processor configured to:
store information regarding an indicator displayed on the meter portion, in a storage device; and
output to the display device, a command to display a screen in accordance with the information regarding the indicator stored in the storage device on the pair of displays; and
transmit information for displaying a first screen on the user terminal, to the user terminal or the server, the first screen being a screen in accordance with the information regarding the indicator displayed on the meter portion.

2. A system comprising:
a display device including a pair of displays provided in front of a driver's seat in a vehicle front-rear direction within a vehicle cabin, arranged on a left side and a right side of a steering wheel while protruding backward in the vehicle front-rear direction from a meter portion disposed in front of the steering wheel, and including a touch panel; and
an information processing device including a processor configured to execute:
output information via the display device;
store information regarding an indicator displayed on the meter portion in a storage device; and
output to the display device, a command to display a screen in accordance with the information regarding the indicator stored in the storage device on the pair of displays.

3. The system according to claim 2, wherein the pair of displays is arranged forward from a gripping portion of the steering wheel in the vehicle front-rear direction.

4. The system according to claim 2, further comprising a microphone that detects utterance of a user,
wherein the processor is configured to
output the command to the display device in response to input of predetermined utterance to the microphone.

5. The system according to claim 2, wherein:
the storage device is configured to store information regarding explanation of the indicator; and
the processor is configured to output the command to the display device such that the explanation of the indicator is displayed on the screen in accordance with the information regarding the indicator.

6. The system according to claim 2, wherein the processor is configured to:
output to the display device, a first command to display a screen that displays a plurality of first display histories of the indicator on the pair of displays;
specify a second display history selected by a user among the first display histories of the indicator displayed on the pair of displays in accordance with a signal from the touch panel; and
output to the display device, a second command to display the screen in accordance with the information regarding the indicator on the pair of displays in accordance with the second display history selected by the user.

7. The system according to claim 2, wherein the processor is configured to transmit information for displaying the screen in accordance with the information regarding the indicator displayed on the meter portion on a user terminal of the user of a vehicle, to the user terminal or an external server that communicates with the user terminal.

8. An information processing device configured to output information via a display device, the information processing device comprising a processor, wherein:
the display device includes a pair of displays provided in front of a driver's seat in a vehicle front-rear direction within a vehicle cabin, arranged at positions on a left side and a right side of a steering wheel while protruding backward in the vehicle front-rear direction from a meter portion disposed in front of the steering wheel, and including a touch panel; and
the processor is configured to:
store information regarding an indicator displayed on the meter portion in a storage device; and
output to the display device, a command to display a screen in accordance with the information regarding the indicator stored in the storage device on the pair of displays.

9. The information processing device according to claim 8, wherein the pair of displays is arranged forward from a gripping portion of the steering wheel in the vehicle front-rear direction.

10. The information processing device according to claim 8, wherein the processor is configured to
output the command to the display device in response to input of predetermined utterance to a microphone that detects utterance of a user.

11. The information processing device according to claim 8, wherein
the storage device is configured to store information regarding explanation of the indicator, and
the processor is configured to output the command to the display device such that the explanation of the indicator is displayed on the screen in accordance with the information regarding the indicator.

12. The information processing device according to claim 8, wherein the processor is configured to:
output to the display device, a first command to display a screen that displays a plurality of first display histories of the indicator on the pair of displays;
specify a second display history selected by the user among the first display histories of the indicator displayed on the pair of displays in accordance with a signal from the touch panel; and
output to the display device, a second command to display the screen in accordance with the information regarding the indicator on the pair of displays based on the second display history selected by the user.

13. The information processing device according to claim 8, wherein the processor is configured to transmit information for displaying the screen in accordance with the information regarding the indicator displayed on the meter portion on a user terminal of the user of a vehicle, to the user terminal or an external server that communicates with the user terminal.
